(19) United States
(12) Patent Application Publication
(10) Pub. No.: US 2026/0049096 A1
(43) Pub. Date: Feb. 19, 2026

(54) AN IMPROVED PROCESS FOR PREPARING ANTIVIRAL PHOSPHONATE ANALOGUES

(71) Applicant: Cipla Limited, Mumbai (IN)

(72) Inventors: Arijit DAS, Porvorim (IN); Ashwini SAWANT, Mumbai (IN)

(21) Appl. No.: 19/101,615

(22) PCT Filed: Aug. 8, 2023
(86) PCT No.: PCT/GB2023/052094

§ 371 Date: Feb. 6, 2025

(30) Foreign Application Priority Data
Aug. 8, 2022 (IN) 202221045237

(51) Int. Cl. C07F 9/6561

(52) U.S. Cl. CPC C07F 9/65616

(57) ABSTRACT

The present invention relates to an improved process for the preparation of (((1-(6-amino-9H-purin-9-yl)propan-2-yloxy)methyl)(phenoxy)phosphoryloxy)methyl pivalate Compound (1) or its pharmaceutically acceptable salts thereof. The compound is useful as nucleotide reverse transcriptase inhibitor in therapy for diseases which respond to inhibition of protein kinase activity in humans in need thereof.

### FIELD OF THE INVENTION

The present invention relates to an improved process for the preparation of (((1-(6-amino-9H-purin-9-yl)propan-2-yloxy)methyl)(phenoxy)phosphoryloxy)methyl pivalate or pharmaceutically acceptable salts and derivatives thereof, as well as pharmaceutical compositions comprising the same, and methods of treating diseases which respond to an inhibition of nucleotide reverse transcriptase activity, such as HIV and/or AIDS, using the same.

### RELATED BACKGROUND ART

The compound (((1-(6-amino-9H-purin-9-yl)propan-2-yloxy)methyl)(phenoxy)phosphoryloxy)methyl pivalate of Formula (1) and pharmaceutically acceptable salts thereof is disclosed in U.S. Pat. No. 9,227,990 B2.

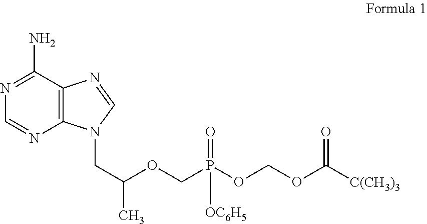

The compound (((1-(6-amino-9H-purin-9-yl)propan-2-yloxy)methyl)(phenoxy)phosphoryloxy) methyl pivalate of Formula (I) may exist as a diastereomer having either the (R,R), (S,S), (R,S) or (S,R) configuration. Preferably, the compound of Formula (I) or the acid salt thereof is in the form of the (R,R) diastereomer. Accordingly, the salts of (((1-(6-amino-9H-purin-9-yl)propan-2-yloxy)methyl) (phenoxy) phosphoryloxy) methyl pivalate of Formula (I) obtained by the process of the present invention may also include all diastereomers occurring in the salts.

Valuable pharmacological properties are attributed to this compound. It can be used, for example, as a nucleotide reverse transcriptase inhibitor useful in therapy for diseases which respond to inhibition of protein kinase activity.

The earliest known synthesis of compound of Formula (1), by Phull et al., is described in U.S. Pat. No. 9,227,990 B2. The synthetic method employed in '990 US document is depicted in the following reaction Scheme 1.

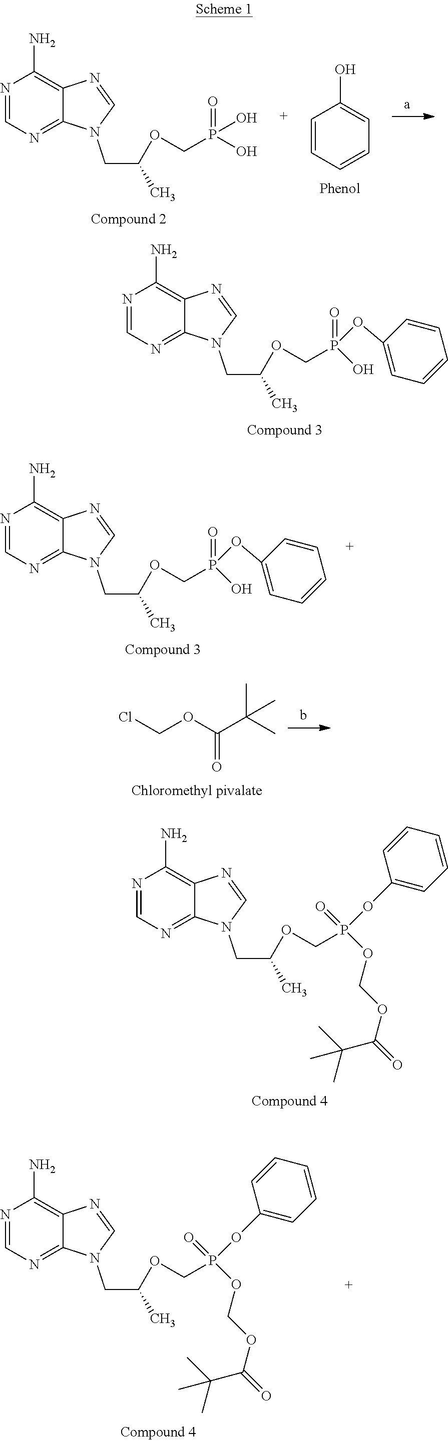

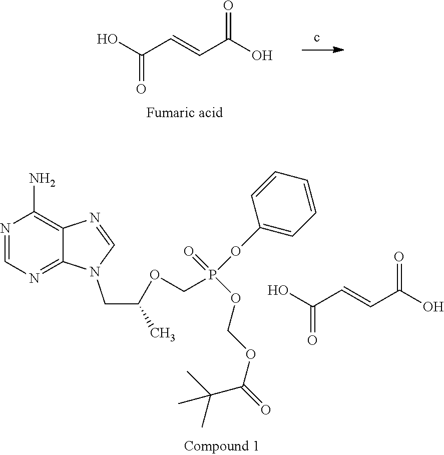 [SMILES: O=C(O)/C=C/C(=O)O ; C[C@H](Cn1cnc2c(N)ncnc21)OCP(=O)(OCOC(=O)C(C)(C)C)Oc1ccccc1 ; O=C(O)/C=C/C(=O)O]

Starting from (R)-9-(2-Phosphonomethoxypropyl) adenine (PMPA, having the structure of compound of Formula (2) a literature procedure was used to prepare the compound of Formula (3) via a coupling reaction using N,N-dicyclohexylcarbodimide as a coupling agent and phenol as reactant in solvent N-methyl pyrrolidone (Step a). Compound of Formula (3) was isolated and reacted with chloromethyl pivalate in a solvent, namely N-methyl pyrrolidone and the compound of Formula (1) was isolated as a fumarate salt (Step b).

While the synthesis provided by U.S. Pat. No. 9,227,990 B2 is the best known to date, it nevertheless, suffers from certain drawbacks associated with manufacturing higher quantity of this active pharmaceutical ingredient.

The main disadvantages for the synthesis of compound of Formula (1) that had to be addressed before the scale-up were the following:
1. N-methyl pyrrolidone was used as solvent in Step a and Step b. N-methyl pyrrolidone is a high boiling solvent and known to human & environmental hazard, and is difficult to remove completely and hence replacement of this solvent was necessary.
2. Reaction mechanism to be studied to control impurity formation and eventually increasing yield.
3. Lower yield in each stage, inconsistency in reaction conversion demanded to a quality by design approach for scale up of compound of Formula (1).

These problems combined to decrease the efficiency of larger scale processes. Thus, there is a need in the art for an improved low cost and high-yield synthesis of compound of Formula (1), suitable for industrial scale.

The process of the present invention provides large scale synthesis of compound of Formula (1), and its pharmaceutical acceptable salts having high degree of chromatographic and diastereomeric purity and low residual solvent content. Such improved processes may provide higher yields, be easier to perform, or use less costly or toxic reagents than currently available processes.

### OBJECT OF THE INVENTION

The object of the present invention is to provide an improved process for preparing a compound of Formula (1) or pharmaceutically acceptable salts thereof, preferably in high diastereomeric purity.

Yet another object of the present invention is to provide an improved process for preparing a compound of Formula (3).

Yet another object of the present invention is to provide a green process for the synthesis of compound of Formula (1) or pharmaceutically acceptable salts thereof which is simple, economical and suitable for industrial scale-up.

### SUMMARY OF THE INVENTION

The present invention provides an improved process for preparing a compound of Formula (1) or pharmaceutically acceptable salts thereof;

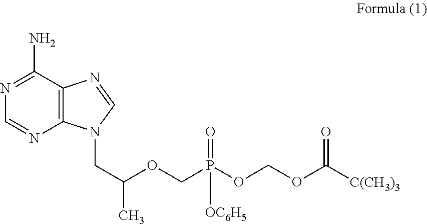

comprising:
   (a) reacting a compound of Formula (2)

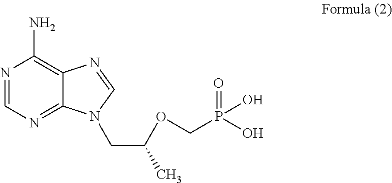 [SMILES: C[C@H](Cn1cnc2c(N)ncnc21)OCP(=O)(O)O]

with triphenylphosphite

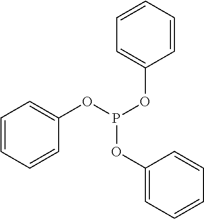 [SMILES: c1ccc(OP(Oc2ccccc2)Oc2ccccc2)cc1]

in the presence of a base, and a solvent to form a compound of Formula (3);

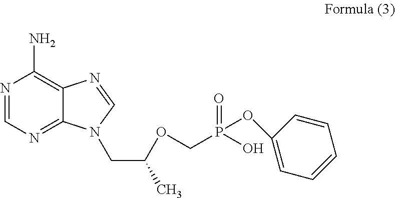 [SMILES: C[C@H](Cn1cnc2c(N)ncnc21)OCP(=O)(O)Oc1ccccc1]

(b) reacting the compound of Formula (3) with chloromethyl pivalate in the presence of a phase transfer catalyst, a base and a solvent to form a compound of Formula (4)

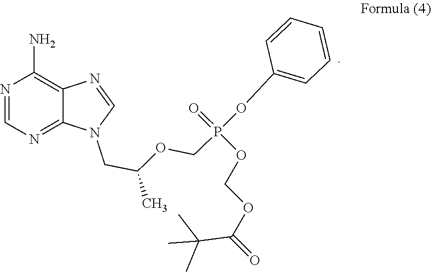 [SMILES: C[C@H](Cn1cnc2c(N)ncnc21)OCP(=O)(OCOC(=O)C(C)(C)C)Oc1ccccc1]

Preferably, the compound of Formula (4) is isolated in the form of a salt such as a phosphate salt or a mesylate salt. The phosphate salt or the mesylate salt of the compound of Formula (4) may be converted to an acid addition salt of the compound of Formula (1). The compound of Formula (4) may be converted to the phosphate salt or mesylate salt by reacting with a phosphoric acid or a methane sulfonic acid to form the respective acid addition salt.

Preferably, the phosphate salt or mesylate salt of the compound of Formula (4) is reacted with a base to form a free base of the compound of Formula (1). The phosphate salt or the mesylate salt of the compound of Formula (4) may be converted to an acid addition salt of the compound of Formula (1) either by first isolating a free base of compound of Formula (1) or without isolating a free base of compound of Formula (1).

Preferably, the phosphate salt or mesylate salt of the compound of Formula (4) is reacted with an acid to form an acid addition salt of the compound of Formula (1). The compound of Formula (1) may be either isolated and converted to its fumarate salt, or not isolated and converted to its fumarate salt, by reacting with a fumaric acid.

The fumarate salt of compound of Formula (1) may contain less than about 0.5% of dipivalate impurities, namely a compound of Formula (4a) and a compound of Formula (4b) as described herein below. Preferably, the fumarate salt of the compound of Formula (1) contains HPLC purity of more than 99%.

Preferably, the compound of Formula (2) is treated with triphenylphosphite in the presence of triethylamine and dimethylaminopyridine and a mixture of a polar aprotic solvent and a non-polar aprotic solvent to form the compound of Formula (3).

Preferably, the compound of Formula (2) is treated with triphenylphosphite in the presence of triethylamine and dimethylaminopyridine in a mixture of acetonitrile and toluene preferably at a temperature in the range of about 60° C. to about 100° C., to form compound of Formula (3). Preferably, the volume ratio of acetonitrile to toluene is 1:1.

The compound of Formula (3) may be reacted with chloromethyl pivalate at a temperature in the range of about 55° C. to about 65° C., preferably for about 3 hours to about 6 hours.

Further, the present invention provides (((1-(6-amino-9H-purin-9-yl)propan-2-yloxy)methyl) (phenoxy) phosphoryloxy) methyl pivalate or compound of Formula (1) or pharmaceutically acceptable salts thereof, prepared according to the process described above, preferably having a purity of more than about 95%, preferably at least 99%, more preferably at least 99.5% by HPLC.

Accordingly, (((1-(6-amino-9H-purin-9-yl)propan-2-yloxy)methyl) (phenoxy) phosphoryloxy) methyl pivalate or compound of Formula (1) or pharmaceutically acceptable salts thereof obtained by the process of the present invention may also include all diastereomers. Preferably, (((1-(6-amino-9H-purin-9-yl)propan-2-yloxy)methyl) (phenoxy) phosphoryloxy) methyl pivalate or the compound of Formula (1) or the acid salt thereof are in the form of the (R,R) diastereomer.

According to another aspect of the present invention, there is provided fumaric acid salt of (((1-(6-amino-9H-purin-9-yl)propan-2-yloxy)methyl)(phenoxy) phosphoryloxy)methyl pivalate or fumaric acid salt of compound of Formula (1) prepared according to the process of the present invention, preferably, having a purity of more than about 95%, preferably at least 99%, more preferably at least 99.5% by HPLC.

The invention is further directed to a pharmaceutical composition comprising:
(a) (((1-(6-amino-9H-purin-9-yl)propan-2-yloxy)methyl) (phenoxy) phosphoryloxy) methyl pivalate, a compound of Formula (1) as described above or an acid salt of thereof, which may be present in crystalline or amorphous form, or solvate or hydrate thereof prepared according to the process of the present invention; and
(b) at least one pharmaceutically acceptable excipient. Preferably, the compound is the fumaric acid salt of (((1-(6-amino-9H-purin-9-yl)propan-2-yloxy)methyl) (phenoxy)phosphoryloxy)methyl pivalate (compound of Formula (1)). More preferably, the compound is the fumaric acid salt of compound of Formula (1) in the R, R diastereomeric form.

According to another aspect of the present invention, there is provided a compound of Formula (1) as described above or a pharmaceutical composition comprising(((1-(6-amino-9H-purin-9-yl)propan-2-yloxy)methyl) (phenoxy) phosphoryloxy) methyl pivalate, or a compound of Formula (1) as described above together with one or more pharmaceutically acceptable carriers for use in treating a disease which responds to an inhibition of nucleotide reverse transcriptase activity, such as HIV and/or AIDS. Preferably, the compound is the fumaric acid salt of compound of Formula (1). More preferably, the compound is the fumaric acid salt of compound of Formula (1) in the R, R diastereomeric form.

The present invention is also directed to a method of treating a disease which responds to an inhibition of nucleotide reverse transcriptase activity, such as HIV and/or AIDS, comprising the step of administering to a subject in need of such treatment a therapeutically effective amount of (((1-(6-amino-9H-purin-9-yl)propan-2-yloxy)methyl) (phenoxy) phosphoryloxy) methyl pivalate), the compound of Formula (1) as described above, or an acid salt or a solvate or hydrate thereof, prepared according to the process of the present invention. Preferably, the acid salt is the fumaric acid salt of compound of Formula (1) prepared by any method described herein. More preferably, the compound is the fumaric acid salt of compound of Formula (1) in the R, R diastereomeric form.

According to another aspect of the present invention, there is provided the use of a compound of Formula (1) as described above or a pharmaceutical composition comprising a compound of Formula (1) as described above together with one or more pharmaceutically acceptable carriers in the manufacture of a medicament for the treatment of a disease which responds to an inhibition of nucleotide reverse transcriptase activity, such as HIV and/or AIDS. Preferably, the compound is (((1-(6-amino-9H-purin-9-yl)propan-2-yloxy)methyl)(phenoxy)phosphoryloxy)methyl pivalate. Preferably, the compound is the fumaric acid salt of compound of Formula (1). More preferably, the compound is the fumaric acid salt compound of Formula (1) in the R, R diastereomeric form.

### DETAILED DESCRIPTION OF THE INVENTION

According to one aspect of the present invention, there is provided an improved synthesis of (((1-(6-amino-9H-purin-9-yl)propan-2-yloxy)methyl) (phenoxy) phosphoryloxy) methyl pivalate (compound of Formula (1)) or pharmaceutically acceptable salts and derivatives thereof. The process of the present invention may be, as depicted below in the reaction scheme 2.

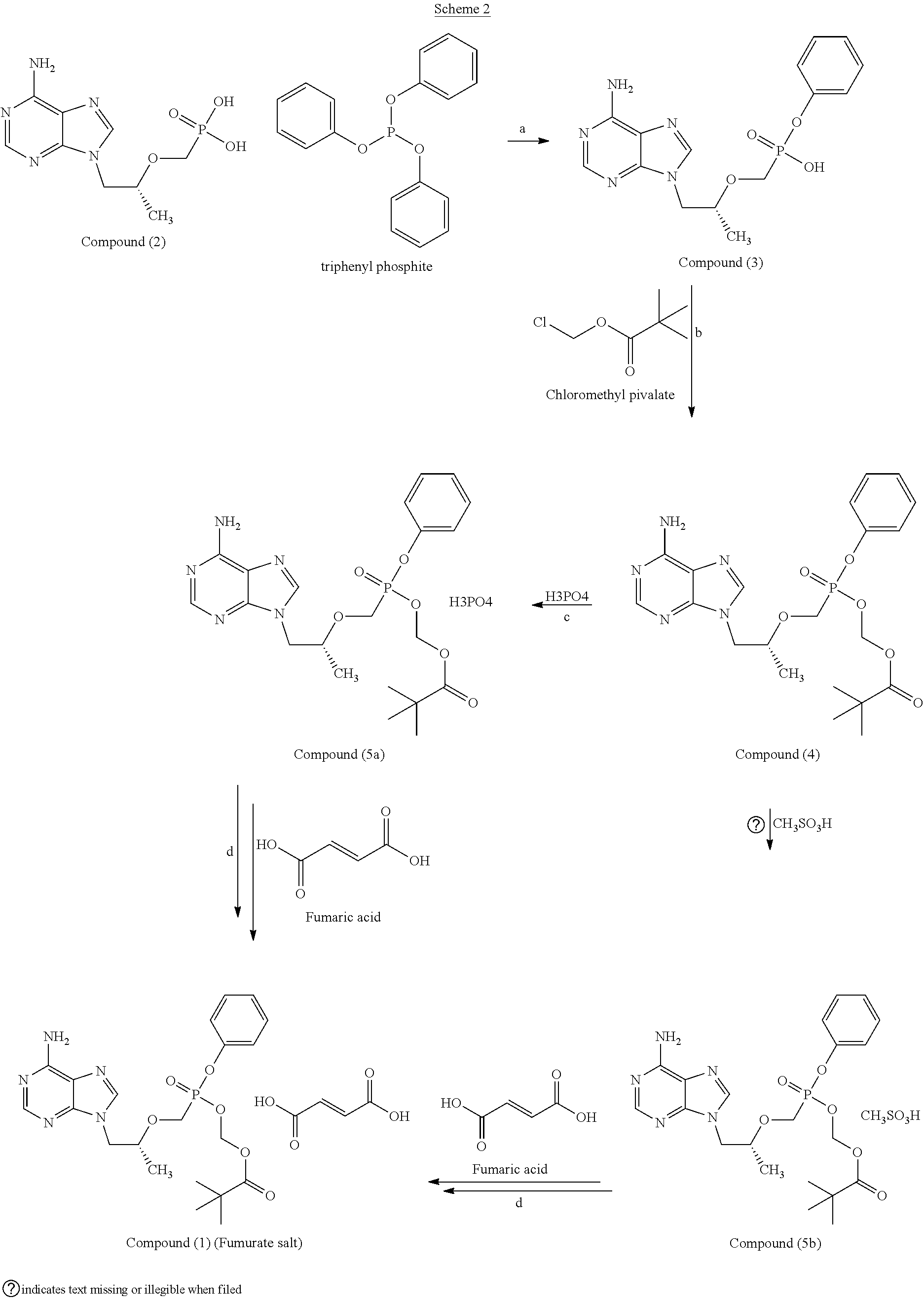

According to another aspect of the present invention there is provided a compound of Formula (3), which is a synthetic intermediate that is useful for preparing the compound of Formula (1).

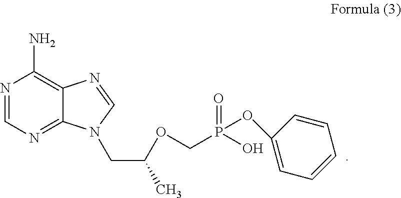 [SMILES: C[C@H](Cn1cnc2c(N)ncnc21)OCP(=O)(O)Oc1ccccc1]

The method for synthesizing a compound of Formula (1) or a pharmaceutically acceptable salt thereof of the present invention may involve the following process steps:
(a) reacting a compound of Formula (2) with triphenylphosphite in the presence of a base and a solvent to form a compound of Formula (3); and
(b) reacting the compound of Formula (3) with chloromethyl pivalate in the presence of a phase transfer catalyst, a base and a solvent to form a compound of Formula (4).

In one aspect of the present invention, (R,R) isomer of the compound of Formula (2) may be used in step (a).

A suitable base used for the reaction in step (a) may be an organic base. Organic bases may be aliphatic or aromatic and may be selected from, but not limited to, trialkylamine, triethylamine, di-isopropyl amine, diethyl amine, pyridine, picoline, piperidine, 2-methylimidazole, dimethylaminopyridine (DMAP), N,N-diisopropylethylamine, 1,5-diazobicyclo[4.3.0]non-5-ene (DBN), 1,8-diAzabicyclo[5.4.0]undec-7-ene (DBU) or a mixture thereof.

Preferably, the reaction in step (a) is carried out in the presence of mixture of bases selected from amine bases such as triethylamine, di-isopropyl amine, diethyl amine, and 4N, N-dimethylaminopyridine(DMAP); most preferably a mixture of triethylamine and DMAP.

Preferably, the reaction in step (a) is carried out in the presence of a solvent selected from a polar aprotic solvent, non-polar aprotic solvent or a mixture thereof. Preferably, the reaction in step (a) is carried out in a mixture of a polar aprotic solvent and non-polar aprotic solvent selected from ketone, C₁ to C₅ nitriles, C₄ to C₇ ethers, C₅ to C cyclic ethers, C₂ to C₇ esters, C₁ to C₆ halogenated hydrocarbons, or C₆ to C₁₄ aromatic hydrocarbons.

Preferably, the polar aprotic solvent is selected from the group consisting of: acetone, methyl ethyl ketone, acetonitrile, propionitrile, ethyl acetate, methyl acetate, propyl acetate, isopropyl acetate, dimethylformamide, dimethylsulfoxide, and a mixture thereof. Preferably, the polar aprotic solvent is acetonitrile, propionitrile or a mixture of acetonitrile and propionitrile.

Preferably, the non-polar aprotic solvent is selected from the group consisting of: toluene, xylene, cyclohexane, dichloromethane, chloroform, dioxane, tetrahydrofuran, diethyl ether, diisopropyl ether, methyl tert-butylether and mixtures thereof. Preferably, the non-polar aprotic solvent is toluene, cyclohexane, or a mixture of toluene and cyclohexane.

The w/v ratio of the compound of Formula (2) to the solvent(s) may be in the range of about 1:1 to about 1:5. Preferably, the w/v ratio of the compound of Formula (2) to the solvent(s) may be in the range of about 1:2 to about 1:3.

Preferably, the w/v ratio of the polar aprotic solvent to the non-polar aprotic solvent may be in the range of about 1:1 to about 1:3.

Preferably, the reaction in step (a) is carried out in a mixture of acetonitrile and toluene.

The v/v ratio of acetonitrile to toluene may be 1:1.

Preferably, the reaction in step (a) is carried out at a temperature in the range of from about 25° C. to about 120°, more preferably from about 40° C. to about 110° C., and most preferably in the range of from about 60° C. to about 100° C.

Preferably, the reaction in step (a) is carried out for about 10 hours to about 50 hours, more preferably, for about 20 hours to about 45 hours, and most preferably, for about 30 hours to about 40 hours.

Preferably, the reaction in step (a) is carried out at a temperature in the range of from about 25° C. to about 120° C. for about 10 hours to about 50 hours. More preferably, the reaction is carried out at a temperature in the range of from about 40° C. to about 110° C., for about 20 hours to about 45 hours. Most preferably, the reaction is carried out at a temperature in the range of from about 60° C. to about 100° C., for about 30 hours to about 40 hours.

In one preferred aspect of the present invention, use of a biphasic solvent in the reaction has certain advantages over conventional process.

In the conventional process of preparing a compound of Formula of (1), N-methyl pyrrolidone, which is a high boiling solvent and known to human and environmental hazard, is used. Also, in the conventional process traces of N-methyl pyrrolidone are difficult to remove completely from the reaction mass, leading to the loss of yield and hence replacement of this solvent was found to be advantages.

Inventor of the present invention found that by carrying out the reaction in a biphasic solvent mixture not only led to a scalable, but economically feasible green process as well. Further, in the conventional process after completion of the reaction, solvent is distilled from the reaction mass and then the reaction mass is again treated with biphasic solvents. Whereas in the process of present invention, preferably, after completion of the reaction, organic and aqueous phases are separated and thus avoids solvent distillation as reported in the prior art.

Further, in the conventional process, the aqueous phase is seeded with 0.05% of compound of Formula (3), whereas in the process of the present invention seeding with compound of Formula (3) of aqueous phases, is not necessary.

Preferably, in the process of the present invention after completion of reaction, aqueous phases are separated, optionally washed with any suitable organic solvents to remove organic impurities. The aqueous phase is then acidified and the compound of Formula (3) is isolated, for example by filtration.

Preferably, the compound of Formula (3) in step (b) is reacted with chloromethyl pivalate in the presence of a suitable phase transfer catalyst, a suitable base and a solvent, to yield a compound of Formula (4).

Preferably, the compound of Formula (1) is in the form of the free base. The free base of compound of Formula (1) may be prepared by reacting an acid salt of the compound of Formula (4) with a suitable base.

Preferably, the compound of Formula (1) is in the form of a pharmaceutically acceptable acid addition salt thereof. Preferably, the acid addition salt of compound of Formula (1) may be prepared by reacting an acid salt of the compound of Formula (4) with a suitable acid, or by converting the free base compound of Formula (1) to the acid addition salt thereof by reaction with the corresponding acid. For example, the free base of compound of Formula (1) or an acid salt of the compound of Formula (4) may be reacted with fumaric acid to form the corresponding compound of Formula (1) in the form of the fumaric acid addition salt thereof. It will be appreciated that other salts may be formed using analogous methods.

Preferably, the free base of the compound of Formula (1) is formed by either isolating or without isolating the phosphate salt or mesylate salt of the compound of Formula (4) and reacting with a base.

The phosphate salt or the mesylate salt of the compound of Formula (4) may be converted to an acid addition salt of the compound of Formula (1) either by first isolating the free base compound of Formula (1) or without isolating the free base compound of Formula (1).

Preferably, the phosphate salt or mesylate salt of the compound of Formula (4) is reacted with an acid to form an acid addition salt of the compound of Formula (1). The compound of Formula (1) may be either isolated and converted to its acid addition salt such as a fumarate salt, or not isolated and converted to its acid addition salt such as fumarate salt, by reacting with a fumaric acid.

When the reaction in the conversion of compound of Formula (3) to compound of Formula (1) was monitored closely, it was observed that during the reaction, the compound of Formula (3) partially degrades back to compound of Formula (2), which in turn couples with chloromethyl pivalate and leads to the formation of dipivalate impurities, namely compound of Formula (4a) and compound of Formula (4b) as depicted below.

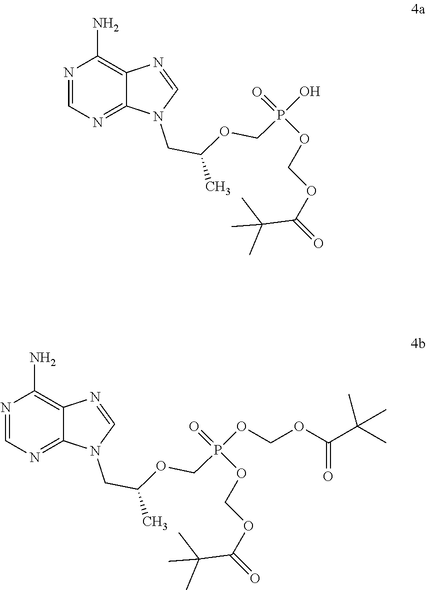 [SMILES: C[C@H](Cn1cnc2c(N)ncnc21)OCP(=O)(O)OCOC(=O)C(C)(C)C ; C[C@H](Cn1cnc2c(N)ncnc21)OCP(=O)(OCOC(=O)C(C)(C)C)OCOC(=O)C(C)(C)C]

These impurities were found to be difficult to remove, impacting on the conversion rate and leads to lesser yield.

Further, the prior art teaches use of dipolar aprotic solvent like N-methyl pyrrolidone. N-methyl pyrrolidone, being a high boiling solvent and not green because of its detrimental effects on human health and hazards to the natural environment caused by its inescapable toxicity as well as large wastewater streams and high-energy-input requirements. Further, traces of N-methyl pyrrolidone are found difficult to remove completely from the reaction mass, leading to the loss of yield and hence replacement of this solvent was necessary. Therefore, minimizing and avoiding the use of such solvents has become one of the most important facets of green chemistry.

The solvent for use in step (b) may be selected from an aprotic organic solvent, water, or a mixture of an aprotic organic solvent and water.

Preferably, the reaction in step (b) is carried out in the presence of an aprotic organic solvent. The aprotic organic solvent is preferably selected from the group consisting of: C₁ to C₅ nitriles, C₂ to C₇ ester, carbonic esters, C₄ to C₇ ethers, C₅ to C₈ cyclic ethers, water and mixtures thereof.

Preferably, the aprotic organic solvent is selected from the group consisting of: acetonitrile, propionitrile, ethyl acetate, methyl acetate, propyl acetate, isopropyl acetate, dimethyl carbonate, ethylene carbonate, propylene carbonate, dioxane, tetrahydrofuran, dimethylacetamide, dimethylformamide, dimethylsulfoxide, water and mixtures thereof. More preferably, the solvent is selected from acetonitrile, dioxane, dimethyl carbonate, ethylene carbonate, propylene carbonate, dimethylacetamide, dimethylformamide, and water or mixtures thereof; most preferably acetonitrile, dioxane, dimethyl carbonate or mixtures thereof.

A suitable base used for the reaction in step (b) may be an organic base. Organic bases may be aliphatic or aromatic amines and may be selected from, but not limited to triethyl amine, di-isopropyl amine, pyridine, picoline, diethyl amine, DBU, piperidine, N, N-diisopropylethylamine or mixtures thereof. More preferably, bases are selected from triethyl amine, N, N-diisopropylethylamine, DBU, or mixtures thereof. Most preferably, the organic base is N, N-diisopropylethylamine.

The reaction in step (b) is preferably carried out at a temperature in the range of about 30° C. to about 90° C., preferably in the range of about 40° C. to about 80° C., more preferably in the range of about 55° C. to about 65° C.

Preferably, the reaction in step (b) is maintained for about 1 hour or more, for example about 10 hours or more, or about 20 hours or more. More preferably, the reaction is maintained for about 2 hours to about 8 hours. Most preferably, the reaction is maintained for about 3 hours to about 6 hours.

Preferably, in step (b) the compound of Formula (3) is reacted with chloromethyl pivalate by a coupling reaction in the presence of a phase transfer catalyst.

Preferably, the phase transfer catalyst is selected from the group consisting of: tetrabutyl ammonium bromide, benzyltriethylammonium chloride, methyltricaprylammonium chloride, methyltributylammonium chloride, tetramethyl ammonium bromide, trimethylpropyl ammonium bromide, benzyltributylammonium chloride, tetraethyl ammonium bromide and a mixture thereof. Most preferably, the phase transfer catalyst is tetrabutyl ammonium bromide.

The inventors of the present invention found that by carrying out the reactions in an aprotic organic solvent or a mixture of aprotic organic solvents not only led to a scalable, but economically feasible green process as well.

Further, it was found that in the process of the present invention the amount of dipivalate impurities, such as compound of Formula (4a) and compound of Formula (4b) reduced below detection limit leading to better conversion and improved yield of compound of Formula (4).

Compound of Formula (4) obtained by the process of present invention may be converted to an acid addition salt of pure compound of Formula (1), either by first isolating the free base of compound of Formula (4) or without isolating the free base of compound of Formula (4).

In one aspect of the present invention, the compound of Formula (4) is preferably not isolated, i.e. the free base of compound of Formula (4) is converted to an acid salt compound of Formula (1) in situ.

In another aspect of the present invention, the compound of Formula (4) is preferably isolated as a phosphate salt (compound of Formula 5a as depicted below). Preferably, the compound of Formula (4) is isolated as methane sulfonate salt (compound of Formula 5b as depicted below).

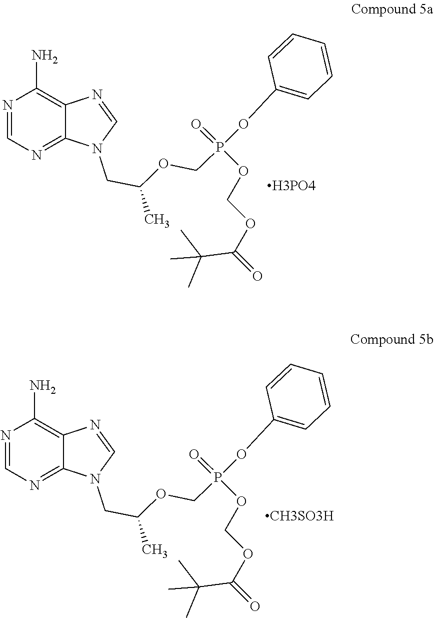 [SMILES: C[C@H](Cn1cnc2c(N)ncnc21)OCP(=O)(OCOC(=O)C(C)(C)C)Oc1ccccc1 ; C[C@H](Cn1cnc2c(N)ncnc21)OCP(=O)(OCOC(=O)C(C)(C)C)Oc1ccccc1]

In one aspect of the present invention, the compound of Formula (4) may be dissolved in a suitable solvent to form a solution to facilitate the formation of the acid salt of compound of Formula (4). Suitable solvent includes, but are not limited to, an organic solvent preferably selected from the group consisting of: ketone, C₂ to C₇ ester, C₄ to C₇ ethers, C₁ to C₅ alcohol, aliphatic hydrocarbon, C₆-C₁₀ substituted aromatic hydrocarbons, C₁-C₅ halogenated hydrocarbons and mixtures thereof. Preferably, the organic solvent is selected from the group consisting of: acetone, methyl isobutyl ketone, acetonitrile, dimethylformamide, dimethylsulfoxide, N-methyl-2-pyrrolidone, ethyl acetate, toluene, xylene, dichloromethane, chloroform, dioxane, tetrahydrofuran, diethyl ether, methanol, ethanol, isopropanol, n-propanol, tert-butanol, tert-amyl alcohol and mixtures thereof. Preferred solvents are acetone, methyl isobutyl ketone, N-methyl-2-pyrrolidone, dimethylformamide, alcohols or combinations thereof. Most preferably, the solvent is a mixture of methanol and ethyl acetate or a mixture of methanol and acetone.

The solution containing the compound of Formula (4) may be treated with any acid to form the corresponding acid addition salt. Preferably, the solution containing the compound of Formula (4) is treated with either phosphoric acid or methane sulfonic acid to form the respective acid addition salt. The acid may be in the form of a solution or solid. The resulting acid addition salt may be isolated as a solid by any known technique, including but not limited to, cooling, chilling, completely or partially distilling solvents, and/or filtering.

Alternatively, the acid addition salts of compound of Formula (1), may be prepared in accordance with the present invention by a salt interconversion method, preferably as depicted in Scheme 3.

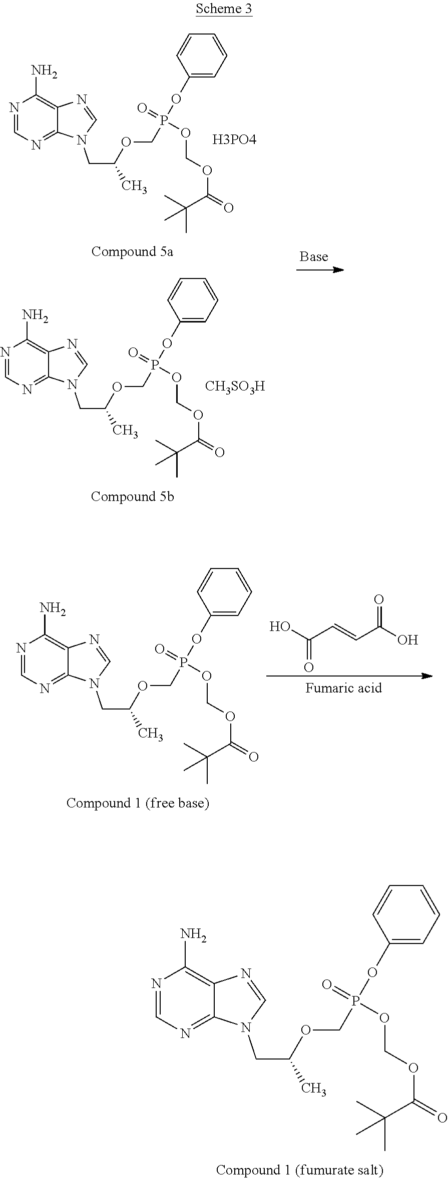

This process may involve reacting an acid salt of the compound of Formula (4) such as compound of Formula 5(a) or 5(b) with a suitable base to form the free base of compound of Formula (1) as shown in the above scheme 3. The free base of compound of Formula (1) may then be converted into an acid salt form of compound of Formula (1), by reacting with an acid such as a fumaric acid as shown in the above scheme 3.

Examples of the pharmaceutically acceptable acid addition salt of compound of Formula (1) include, but are not limited to, inorganic acid salts such as hydrochloric acid salt, sulfuric acid salt, nitric acid salt, hydrobromic acid salt, hydroiodic acid salt and phosphoric acid salt, organic carboxylic acid salts such as acetic acid salt, lactic acid salt, citric acid salt, oxalic acid salt, glutaric acid salt, malic acid salt, tartaric acid salt, fumaric acid salt, mandelic acid salt, maleic acid salt, benzoic acid salt and phthalic acid salt; and organic sulfonic acid salts such as methanesulfonic acid salt, ethane sulfonic acid salt, benzenesulfonic acid salt, p-toluene sulfonic acid salt and camphorsulfonic acid salt. Among these, fumaric acid, tartaric acid, citric acid, salicylic acid, acetic acid, succinic acid, d(-)tartaric acid, oxalic acid, and methane sulfonic acid are more preferred, but the acid addition salt is not restricted thereto. Preferably, the compound of Formula (1) is converted to the fumarate salt.

Advantages of the process of the present invention are that it removes unreacted starting materials as well as undesired impurities formed in both stages (i.e in step (a) and in step (b)). Thus, in one aspect, the process of the present invention is advantages as the isolated acid salt of compound of Formula (1) has purity of more than 98%. Preferably, the acid salt of compound of Formula (1) of the present invention has purity of more than 99%.

Further, salts and more specifically phosphate salt (for example, compound of Formula (5a)) and mesylate salt (for example, compound of Formula (5b)), are easy to purify, handle and store on large scale. Hence, suitable for industrial synthesis.

Further, it was found that the isolated salts obtained by the process of the present invention are not hygroscopic and are readily soluble in physiologically acceptable solvents.

The salts of the present invention may be crystalline or noncrystalline.

In certain aspects, the acid salts and polymorphic forms described herein may potentially exhibit improved properties. For example, in certain aspects, the acid salts and polymorphic forms described herein may potentially exhibit improved stability, improved pharmacokinetic properties and/or potentially improved bioavailability. Such improved stability could have a potentially beneficial impact on the manufacture of the compound of Formula (1), such as for example having the ability to store process intermediates for extended periods of time. Improved stability could also potentially benefit a composition or pharmaceutical composition of the compound of Formula (1). In further aspects, the salts and polymorphic forms described herein may also potentially result in improved yield of the compound of Formula (1), or potentially result in an improvement of the quality of the compound of Formula (1).

The (S,S), (R,S), (S,R) or (R,R) configuration of the compound of Formula (1) or the acid salt thereof may be prepared by using the (S,S), (R,S), (S,R) or (R,R) of the compound of Formula (2).

In another aspect of the present invention there is provided a pharmaceutical composition comprising (a) a compound of Formula I or its acid salts; and (b) one or more pharmaceutically acceptable excipients. Any suitable pharmaceutically acceptable excipients that are known in the art may be used.

In another aspect of the present invention there is provided a method of treating or preventing a disease which responds to an inhibition of nucleotide reverse transcriptase activity, such as HIV and/or AIDS comprising administering to a subject in need of such treatment an effective amount of at least one of compound of Formula I or its acid salts obtained by the processes of the present invention or a pharmaceutical composition described herein.

In another aspect of the present invention there is provided use of a compound of Formula I or its acid salts obtained by the processes of the present invention or a pharmaceutical composition described in the preparation of a medicament for the treatment of diseases which responds to an inhibition of nucleotide reverse transcriptase activity, such as HIV and/or AIDS.

The following examples, which include preferred aspects, will serve to illustrate the practice of this invention, it being understood that the particulars shown are by way of example and for purpose of illustrative discussion of preferred aspects of the invention.

### EXAMPLES

### Example 1: Preparation of Phenyl hydrogen (((R)-1-(6-amino-9H-purin-9-yl)propan-2-yloxy)methyl phosphonate (compound of Formula (3))

PMPA (100 gm, 0.348 mmol) 1,4-dioxane (350 ml, 1.2V), Phenol (62.2 gms, 0.661 mmol) and triethylamine (42.22 gm, 0.418 mmol) were added to a 2 L reaction vessel equipped with a mechanical stirrer. The contents of reactor were agitated at 80-85° C. to give a solution. To this solution was charged solution of N, N-dicyclohexyl carbodiimide (111.25 gms, 0.540 mmol) in 1,4-dioxane (50 ml, 0.5V) at 80-85° C. The reactor contents were then heated to 100-105° C. to give a complete solution. The reactor contents were agitated at 100-105° C. for 5 hrs. Reaction mass was sampled and monitored by HPLC. After reaction completion, water (200 ml) was charged to reaction solution, to obtain slurry. Reaction mixture was agitated at 25-30° C. for 1 hr, and filtered at 25-30° C. to remove inorganics. The pH of the clear filtrate was adjusted to 11-12 using 25% sodium hydroxide solution (25 ml), stirring continued for 15 mins at 25-30° C. To this basic solution, ethyl acetate (200 ml, 2V) was added and stirred for 15 mins at 25-30° C. The aqueous layer was separated in 2 litre reactor and the pH of the aqueous layer was adjusted to 2.3-3 using conc. Hydrochloric acid (30 ml). Reaction mixture was agitated for 8-10 hrs at 25-30° C. to ensure complete precipitation. The solids were isolated by filtration, slurred in methanol (1000 ml, 10V) at 25-30° C., filtered, washed with Methanol (250 ml, 2.5V). Solid obtained was dried at 50-55° C. for 8-10 hrs until kf NMT 1.0% to yield 75 gms of compound of Formula (3).

### Example 2: Preparation of Phenyl hydrogen (((R)-1-(6-amino-9H-purin-9-yl)propan-2-yloxy)methyl phosphonate (compound of Formula (3))

PMPA (100 gm, 0.348 mmol), Acetonitrile (150 ml, 1.5V), Triphenylphosphite (162.2 gms, 0.5226 mmol), 4-N,N-dimethylaminopyridine (42.56 gms, 0.3484 mmol), Toluene (150 ml, 1.5V) and triethylamine (7.05 gm, 0.6969 mmol) were added to a 2 L reaction vessel equipped with a mechanical stirrer. The reactor contents were then heated to 80-85° C. to give a complete solution. The reactor contents were agitated at 80-85° C. for 40 hrs. Reaction mass was sampled and monitored by HPLC. After reaction completion, Toluene (200 ml, 2V) and Water (200 ml, 2V) was charged to reaction solution, to obtain a slurry. Reaction mixture was agitated at 25-30° C. for 30 mins. The aqueous layer was separated in 2 litre reactor and washed with Toluene (200 ml, 2V). The aqueous layer was separated in 2 litre reactor and pH of the aqueous layer was adjusted to 2-2.5 using conc. Hydrochloric acid (30 ml). The reaction mixture was agitated for 1 hr at 25-30° C. to ensure complete precipitation, further chilled to 2-8° C. The solids were isolated by filtration, slurred in methanol (1000 ml, 10V) at 25-30° C., filtered, washed with Methanol (250 ml, 2.5V). Solid obtained was dried at 50-55° C. for 8-10 hrs until kf NMT 1.0% to yield 106 gms of compound of Formula (3).

### Example 3: Preparation of (((1-(6-amino-9H-purin-9-yl)propan-2-yloxy)methyl) (phenoxy) phosphoryloxy) methyl Pivalate Phosphate (Compound of Formula (5a))

Phenyl hydrogen (((R)-1-(6-amino-9H-purin-9-yl)propan-2-yloxy)methyl phosphonate (Compound of formula (3)) (100 gm, 0.275 mmol), N,N-diisopropyl ethylamine (72 ml, 52.12 gm, 0.404 mmol), Tetrabutyl ammonium bromide (30 gms, 30%, 0.0930 mmol) and dimethyl carbonate (500 ml, 5V) were charged to 3 L four-neck flask provided with a thermometer, a dropping funnel and a mechanical stirrer. The contents were agitated at 25-30° C. to give a slurry mixture. To this mixture were charged Chloromethyl pivalate (62 gms, 0.4133 mmol) at 25-30° C. The reactor contents were then heated to 55-60° C. to give a complete solution. The reactor contents were agitated at 55-60° C. for 5 hrs. The reaction was sampled and monitored by HPLC. The solvents were evaporated under vacuum to yield 120 gms of compound of Formula (4) as an oil. The reactor contents were cooled to 25-30° C. and dissolved in dichloromethane (500 ml, 5V). Organic layer was washed with 10% sodium dihydrogen orthophosphate (200 ml, 2V, twice). The layers were settled and separated. The organic layer was evaporated under vacuum at 40-45° C. to yield compound of Formula (4) as an oil. The oil was stirred in isopropyl alcohol (500 ml, 5V). The reactor jacket was cooled to 25-30° C. Charged O-phosphoric acid (32.5 gms, 0.3316 mmol) to isopropyl alcohol solution and reactor contents were agitated at 25-30° C. for 30 mins. The reactor jacket was heated to 70-75° C. and reaction mixture was stirred at 70-75° C. for 15 mins to obtain a clear solution. The reactor jacket was cooled to 25-30° C., reaction solution was stirred at 25-30° C. for 2 hrs to obtain slurry. The reactor contents were filtered, and the cake was washed with isopropyl alcohol (100 ml, 1V). The wet cake (160 gms) was used as such for purification. To a 2 litre reactor, the wet cake was charged along with Methanol (200 ml) and Acetone (500 ml) at 25-30° C. The reactor jacket was heated at 65-70° C. and reaction mixture was stirred at 65-70° C. for 15 mins to get a clear solution. The reactor jacket was then cooled to 25-28° C. and stirred for 2 hrs at 25-28° C. The solid were isolated by filtration was washed with acetone (100 ml, 1V) and dried in vacuum tray drying at temperature below 45° C. to yield 100 gms of compound of Formula (5a).

Analysis of compound of Formula (4) on HPLC showed impurities compound of Formula (4a) and compound of Formula(4b) less than 0.5%.

### Example 4: Preparation of (((1-(6-amino-9H-purin-9-yl)propan-2-yloxy)methyl) (phenoxy) phosphoryloxy) methyl Pivalate Methane Sulfonate (Compound of Formula (5b))

Compound 5a (20 gms, 0.034 mmol) along with dichloromethane (200 ml) and water (100 ml) were charged to four necked 2 L reactor with mechanistic stirrer and the reaction mixture was allowed to stir at 20-25° C. to obtain clear solution. Liquor ammonia (20 ml, 1V) was charged to reaction solution at 25° C. under stirring. After stirring the solution for 30 mins, layers allowed to separate. Product was extracted in organic dichloromethane layer; aqueous layer was discarded. Organic layer was washed with 10% sodium dihydrogen phosphate solution (40 ml, 2V), organic layer was collected, dried over sodium sulfate and solvent was evaporated under vacuum below 40° C. to obtain oil. Residue oil was dissolved in mixture of ethyl acetate (100 ml, 5V), and cooled to 15-20° C. To this solution, charged methane sulfonic acid (3.5 gms, 0.0364 mmol) and slurry initially stirred at 15-2° C. and then at 25-30° C. for 30 minutes. The solids were isolated by filtration at 25-30° C., washed with ethyl acetate (20 ml, 1V) and dried in vacuum oven below 40° C. for 5 hrs, to yield 15 gms of compound of Formula (5b), having purity as per HPLC: 99.5% and LOD: <1%.

### Example 5: Preparation of (((1-(6-amino-9H-purin-9-yl)propan-2-yloxy)methyl) (phenoxy) phosphoryloxy) methyl pivalate fumarate (fumarate Salt of Compound of Formula (1))

Compound of Formula (5a), (100 gms, 0.173 mmol) along with dichloromethane (500 ml) and water (200 ml) were charged to four necked 2 L reactor with mechanistic stirrer and the reaction mixture was allowed to stir at 20-25° C. to obtain a clear solution. Liquid ammonia (100 ml, 1V) was charged to reaction solution at 25° C. under stirring. After stirring the solution for 30 mins, layers allowed to separate. Product was extracted in organic dichloromethane layer; aqueous layer was discarded. Organic layer was washed with 10% sodium dihydrogen phosphate solution (200 ml, 2V), organic layer was collected, dried over sodium sulfate and solvent was evaporated under vacuum below 40° C. to obtain oil. Residue oil was dissolved in mixture of isopropyl alcohol (500 ml, 5V) and water (1000 ml, 2V). To this solution was charged Fumaric acid (18.15 gms, 0.156 mmol) and the obtained slurry was heated at 45-50° C. under stirring for 30 minutes. Solution was further cooled to 0-5° C. and stirred at this temperature for 2 hrs. Solids were isolated by filtration at 0-5° C., washed with water (200 ml, 2V) and further dried in vacuum oven below 45° C. for 5 hrs, to yield 60 gms of Compound of Formula (1) having purity as per HPLC: 99.5% and LOD: <1%.

### Example 6: Preparation of (((1-(6-amino-9H-purin-9-yl)propan-2-yloxy)methyl) (phenoxy) phosphoryloxy) methyl Pivalate Fumarate (Fumarate Salt of Compound of Formula (1))

Compound of Formula (5b), (100 gms, 0.173 mmol) along with dichloromethane (500 ml) and water (200 ml) were charged to four necked 2 L reactor with mechanistic stirrer and the reaction mixture was allowed to stir at 20-25° C. to obtain a clear solution. Liquid ammonia (100 ml, 1V) was charged to reaction solution at 25° C. under stirring. After stirring the solution for 30 mins, layers allowed to separate. Product was extracted in organic dichloromethane layer; aqueous layer was discarded. Organic layer was washed with 10% sodium dihydrogen phosphate solution (200 ml, 2V), organic layer was collected, dried over sodium sulfate and solvent was evaporated under vacuum below 40° C. to obtain oil. Residue oil was dissolved in mixture of isopropyl alcohol (500 ml, 5V) and water (1000 ml, 2V). To this solution was charged Fumaric acid (18.15 gms, 0.156 mmol) and the obtained slurry was heated at 45-50° C. under stirring for 30 minutes. Solution was further cooled to 0-5° C. and stirred at this temperature for 2 hrs. Solids were isolated by filtration at 0-5° C., washed with water (200 ml, 2V) and further dried in vacuum oven below 45° C. for 5 hrs, to yield 60 gms of Compound of Formula (1) having purity as per HPLC: 99.5% and LOD: <1%.

### Additional Disclosure

The following are non-limiting, specific features in accordance with the present disclosure:

Feature A: A process for preparing Compound (1) or pharmaceutically acceptable salts thereof;

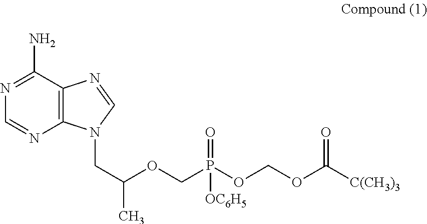

comprising;
a. reacting Compound (2)

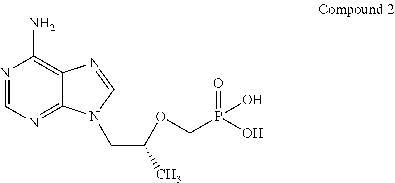 [SMILES: C[C@H](Cn1cnc2c(N)ncnc21)OCP(=O)(O)O]

with triphenylphosphite

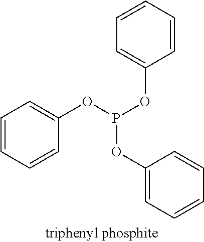 [SMILES: c1ccc(OP(Oc2ccccc2)Oc2ccccc2)cc1]

in the presence of a suitable base, in a polar aprotic solvent or non-polar aprotic solvents or in a mixture thereof to yield Compound (3)

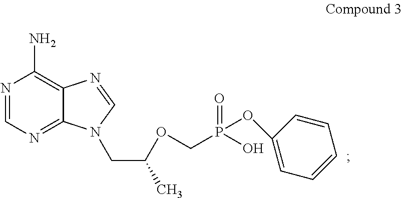 [SMILES: C[C@H](Cn1cnc2c(N)ncnc21)OCP(=O)(O)Oc1ccccc1]

b. reacting Compound (3) with chloromethyl pivalate in the presence of a suitable phase transfer catalyst and a suitable organic base in an aprotic organic solvent, or water or in a mixture of aprotic organic solvent or water thereof to yield Compound (4)

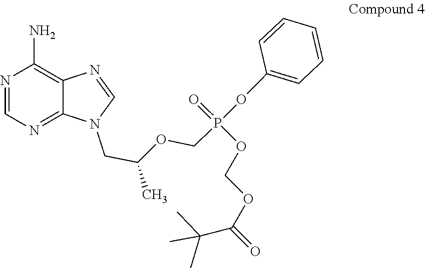 [SMILES: C[C@H](Cn1cnc2c(N)ncnc21)OCP(=O)(OCOC(=O)C(C)(C)C)Oc1ccccc1]

c. optionally, isolating Compound (4) as a phosphate salt (Compound 5a)

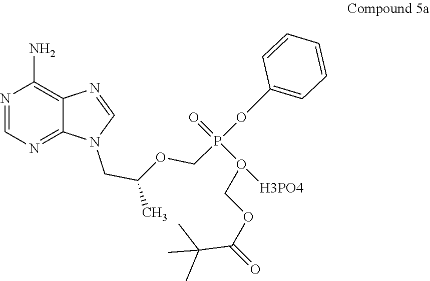

and;
d. optionally, converting phosphate salt Compound (5a) to an acid addition salt of Compound (1), either by first isolating the free base Compound (1) or without isolating the free base Compound (1).

Feature B: The process according to Feature A, wherein compound (1) is having a purity of more than about 95%, preferably at least 99%, more preferably at least 99.5% by HPLC.

Feature C: The process according to Feature A, wherein Compound (2) is treated with triphenylphosphite in the presence of triethylamine and dimethylaminopyridine in a suitable mixture of a polar aprotic solvent or non-polar aprotic solvent to provide Compound (3).

Feature D: The process according to Feature A, wherein the volume ratio of Compound (2) to solvent varies from 1:1 to 1:5.

Feature E: The process according to Feature C, wherein Compound (2) is treated with triphenylphosphite in the presence of triethylamine and dimethylaminopyridine in a mixture of acetonitrile and toluene at a temperature in the range of about 60° C. to about 100° C., to provide Compound (3).

Feature F: The process according to Feature E, wherein the volume ratio of acetonitrile to toluene is 1:1.

Feature G: The process according to Feature A, wherein aprotic organic solvent is selected from acetonitrile, propionitrile, ethyl acetate, methyl acetate, propyl acetate, isopropyl acetate, dimethyl carbonate, ethylene carbonate, propylene carbonate, dioxane, tetrahydrofuran, imethylacetamide, dimethylformamide, and dimethylsulfoxide.

Feature H: The process according to Feature G, wherein aprotic organic solvent is selected from acetonitrile, dioxane and dimethyl carbonate.

Feature I: The process according to Feature A, organic base is selected from, but not limited to triethyl amine, di-isopropyl amine, pyridine, picoline, diethyl amine, DBU, piperidine, N, N-diisopropylethylamine.

Feature J: The process according to Feature A, wherein a phase transfer catalyst is selected from tetrabutyl ammonium bromide, benzyltriethylammonium chloride, methyltricaprylammonium chloride, methyltributylammonium chloride, tetramethyl ammonium bromide, trimethylpropyl ammonium bromide benzyltributylammonium chloride and tetraethyl ammonium bromide or mixture thereof.

Feature K: The process according to Feature A, wherein Compound (3) is treated with chloromethyl pivalate at about 55° C. to about 65° C., for about 3 hours to about 6 hours.

Feature L: The process according to Feature A, wherein Compound (4) is converted to phosphate salt (compound 5a)

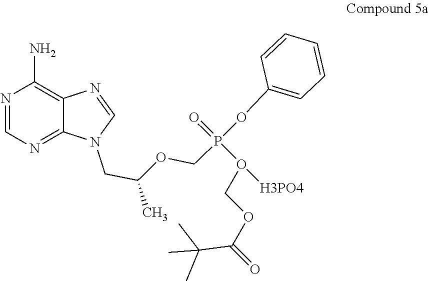

Feature M: The process according to Feature A, wherein Compound (4) is converted to mesylate salt (compound 5b).

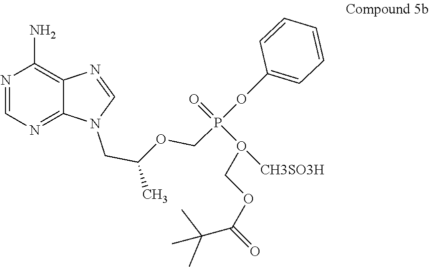

Feature N: The process according to Feature L or Feature M, wherein the resulting phosphate salt (compound 5a) or mesylate salt (compound 5b) is extracted and basified to provide solution of pure Compound (1).

Feature O: The process according to Feature N, wherein the Compound (1) is not isolated and converted to the fumarate salt.

Feature P: The process according to Feature N, wherein the fumarate salt of compound of Formula (1) contains less than about 0.5% of dipivalate impurities, namely compound of Formula (4a) and compound of Formula (4b).

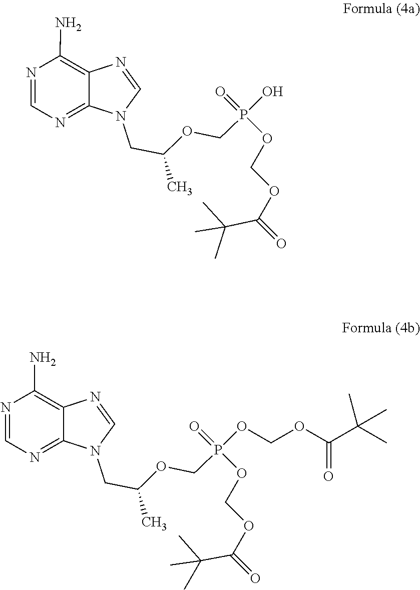 [SMILES: C[C@H](Cn1cnc2c(N)ncnc21)OCP(=O)(O)OCOC(=O)C(C)(C)C ; C[C@H](Cn1cnc2c(N)ncnc21)OCP(=O)(OCOC(=O)C(C)(C)C)OCOC(=O)C(C)(C)C]

Feature Q: The process according to Feature P, wherein the fumarate salt of compound of Formula (1) contains HPLC purity of more than 99%.

Various modifications of the invention in addition to those described herein will become apparent to those skilled in the art from the foregoing description. Such modifications are intended to fall within the scope of the appended claims.

1-29. (canceled)

30. A process for preparing a compound of Formula (1) or pharmaceutically acceptable salts thereof; 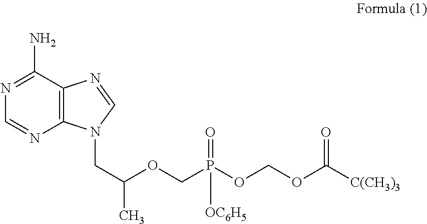
comprising;
(a) reacting a compound of Formula (2) 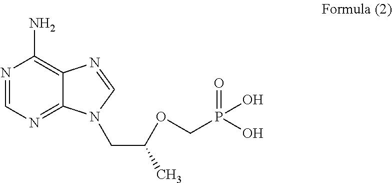 [SMILES: C[C@H](Cn1cnc2c(N)ncnc21)OCP(=O)(O)O]
with triphenylphosphite 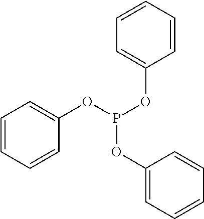 [SMILES: c1ccc(OP(Oc2ccccc2)Oc2ccccc2)cc1]
in the presence of a base, and a solvent to form a compound of Formula (3) 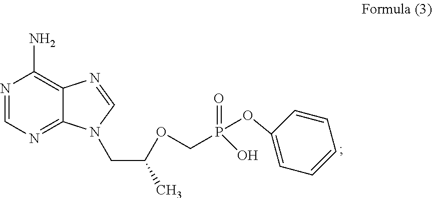 [SMILES: C[C@H](Cn1cnc2c(N)ncnc21)OCP(=O)(O)Oc1ccccc1]
(b) reacting the compound of Formula (3) with chloromethyl pivalate in the presence of a phase transfer catalyst, a base and a solvent to form a compound of Formula (4)

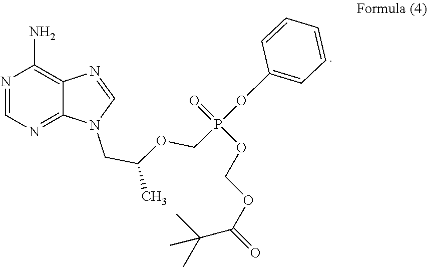 [SMILES: C[C@H](Cn1cnc2c(N)ncnc21)OCP(=O)(OCOC(=O)C(C)(C)C)Oc1ccccc1]

31. The process according to claim 30, further comprising isolating the compound of Formula (4) as a phosphate salt (compound of Formula (5a)), 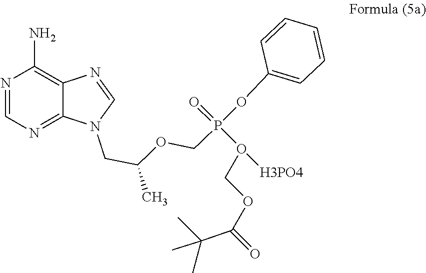
or as a mesylate salt (compound of Formula (5b);

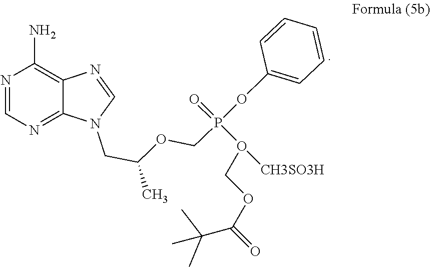

32. The process according to claim 30, further comprising converting the compound of Formula (5a) or the compound of Formula 5(b) to an acid addition salt of compound of Formula (1), preferably either by first isolating a free base of compound of Formula (1) or without isolating a free base of compound of Formula (1), preferably the free base of compound of Formula (1) is formed by reacting the compound of Formula (5a) or the compound of Formula 5(b) with a base.

33. The process according to claim 30, wherein the compound of Formula (1) or its pharmaceutically acceptable salts has a purity of more than about 95%, preferably at least 99%, more preferably at least 99.5% by HPLC.

34. The process according to claim 30, wherein the solvent in step (a) comprises a polar aprotic solvent, a non-polar aprotic solvent, or a mixture thereof; and the solvent in step (b) comprises an aprotic organic solvent, water or a mixture of an aprotic organic solvent and water, preferably the aprotic organic solvent is selected from the group consisting of: acetonitrile, propionitrile, ethyl acetate, methyl acetate, propyl acetate, isopropyl acetate, dimethyl carbonate, ethylene carbonate, propylene carbonate, dioxane, tetrahydrofuran, imethylacetamide, dimethylformamide, dimethylsulfoxide and mixtures thereof; and more preferably the aprotic organic solvent is acetonitrile, dioxane, dimethyl carbonate or a mixture thereof.

35. The process according to claim 30, wherein the base in step (a) is an organic base may selected from the group consisting of: trialkyl amine, triethylamine, di-isopropyl amine, diethyl amine, pyridine, picoline, piperidine, 2-methylimidazole, dimethylaminopyridine (DMAP), N,N-diisopropylethylamine, 1,5-diazobicyclo[4.3.0]non-5-ene (DBN), 1,8-diAzabicyclo[5.4.0]undec-7-ene (DBU) and mixtures thereof; and
the base in step (b) is an organic base selected from the group consisting of: triethyl amine, di-isopropyl amine, pyridine, picoline, diethyl amine, DBU, piperidine, N, N-diisopropylethylamine and mixtures thereof.

36. The process according to claim 30, wherein the phase transfer catalyst is selected from the group consisting of: tetrabutyl ammonium bromide, benzyltriethylammonium chloride, methyltricaprylammonium chloride, methyltributylammonium chloride, tetramethyl ammonium bromide, trimethylpropyl ammonium bromide, benzyltributylammonium chloride, tetraethyl ammonium bromide and mixtures thereof.

37. The process according to claim 30, wherein the volume ratio of compound of Formula (2) to solvent is in the range of from 1:1 to 1:5.

38. The process according to claim 30, wherein the compound of Formula (2) is treated with triphenylphosphite in the presence of triethylamine and dimethylaminopyridine and a mixture of a polar aprotic solvent and a non-polar aprotic solvent to form the compound of Formula (3), preferably the of a polar aprotic solvent and a non-polar aprotic solvent is a mixture of acetonitrile and toluene at a temperature in the range of about 60° C. to about 100° C., to form compound of Formula (3); and preferably the volume ratio of acetonitrile to toluene is 1:1.

39. The process according to claim 30, wherein the compound of Formula (3) is reacted with chloromethyl pivalate at a temperature in the range of about 55° C. to about 65° C., preferably for about 3 hours to about 6 hours.

40. The process according to claim 30, wherein the compound of Formula (4) is converted to a phosphate salt (compound of Formula 5(a)), 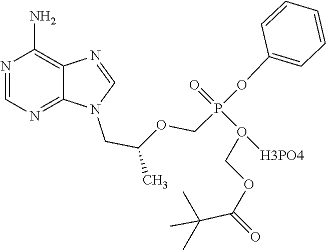
Formula 5(a); preferably the compound of Formula (4) is converted to the phosphate salt by reacting with a phosphoric acid to form the salt.

41. The process according to claim 30, wherein the compound of Formula (4) is converted to a mesylate salt (compound of Formula 5(b)), 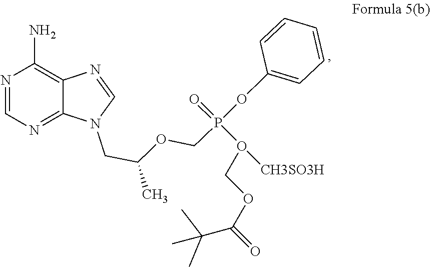
preferably the compound of Formula (4) is converted to the mesylate salt by reacting with a methane sulfonic acid to form the salt.

42. The process according to claim 40, wherein the phosphate salt (compound of Formula (5a)) or mesylate salt (compound of Formula (5b)) is isolated and reacted with a base to form a compound of Formula (1) or not isolated and reacted with a base to form a compound of Formula (1); preferably the compound of Formula (1) is either isolated and converted to its fumarate salt, or not isolated and converted to its fumarate salt, by reacting with a fumaric acid.

43. The process according to claim 40, wherein the phosphate salt (compound of Formula (5a)) or mesylate salt (compound of Formula (5b)) is isolated and reacted with an acid to form an acid addition salt of compound of Formula (1), preferably a fumarate salt of compound of Formula (1) by reacting with a fumaric acid.

44. The process according to claim 30, wherein the fumarate salt of compound of Formula (1) contains:
less than about 0.5% of dipivalate impurities, namely compound of Formula (4a) and compound of Formula (4b). 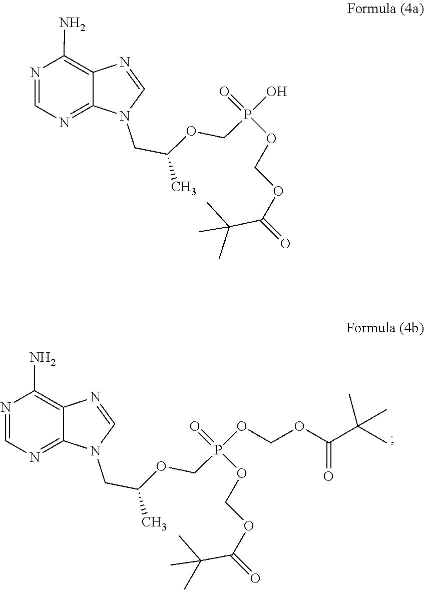 [SMILES: C[C@H](Cn1cnc2c(N)ncnc21)OCP(=O)(O)OCOC(=O)C(C)(C)C ; C[C@H](Cn1cnc2c(N)ncnc21)OCP(=O)(OCOC(=O)C(C)(C)C)OCOC(=O)C(C)(C)C]
HPLC purity of more than 99%.

45. A compound of Formula (1) or its pharmaceutically acceptable salts obtained by the process according to claim 30 having a purity of more than 99%.

46. A pharmaceutical composition comprising (a) a compound according to claim 45; and (b) one or more pharmaceutically acceptable excipients.

47. A method of treating or preventing a disease which responds to an inhibition of nucleotide reverse transcriptase activity, such as HIV and/or AIDS comprising administering to a subject in need of such treatment an effective amount of at least one compound according to claim 45.

48. The process according to claim 41, wherein the phosphate salt (compound of Formula (5a)) or mesylate salt (compound of Formula (5b)) is isolated and reacted with a base to form a compound of Formula (1) or not isolated and reacted with a base to form a compound of Formula (1); preferably the compound of Formula (1) is either isolated and converted to its fumarate salt, or not isolated and converted to its fumarate salt, by reacting with a fumaric acid.

49. The process according to claim 41, wherein the phosphate salt (compound of Formula (5a)) or mesylate salt (compound of Formula (5b)) is isolated and reacted with an acid to form an acid addition salt of compound of Formula (1), preferably a fumarate salt of compound of Formula (1) by reacting with a fumaric acid.
